(19) United States
(12) Patent Application Publication
(10) Pub. No.: US 2010/0076780 A1
(43) Pub. Date: Mar. 25, 2010

(54) METHODS AND APPARATUS TO ORGANIZE PATIENT MEDICAL HISTORIES

(75) Inventors: Prakash Mahesh, Hoffman Estates, IL (US); Murali Kumaran Kariathungal, Hoffman Estates, IL (US); Christopher Janicki, Sleepy Hollow, IL (US)

Correspondence Address: HANLEY, FLIGHT & ZIMMERMAN, LLC, 150 S. WACKER DRIVE, SUITE 2100, CHICAGO, IL, 60606, US

(73) Assignee: General Electric Company, A New York Corporation, Schenectady, NY (US)

(21) Appl. No.: 12/236,230

(22) Filed: Sep. 23, 2008

(51) Int. Cl. G06Q 50/00

(52) U.S. Cl. 705/2

(57) ABSTRACT

Methods and apparatus to organize patient medical histories are disclosed herein. An example method includes receiving a medical report and analyzing the medical report to extract information related to a clinical event associated with the medical report; assigning a classification to the medical report using the extracted information; determining a severity of the clinical event associated with the medical report using the extracted information and assigning a severity score to the medical report; updating a record corresponding to the medical report in a data store to reflect the assigned classification and severity score; and enabling a healthcare practitioner to query the data store using the classification and severity score.

### FIELD OF THE DISCLOSURE

The present disclosure relates generally to healthcare information systems and, more particularly, to methods and apparatus to organize patient medical histories.

### BACKGROUND

Healthcare environments, such as hospitals and clinics, typically include information systems (e.g., hospital information systems (HIS), radiology information systems (RIS), storage systems, picture archiving and communication systems (PACS), etc.) to manage clinical information such as, for example, patient medical histories, imaging data, test results, diagnosis information, management information, financial information, and/or scheduling information. The information may be centrally stored or divided at a plurality of locations. Healthcare practitioners may desire to access patient information or other information at various points in a healthcare workflow. For example, during surgery, medical personnel may access patient information, such as images of a patient's anatomy, which are stored in a medical information system. Alternatively, medical personnel may enter new information, such as history, diagnostic, or treatment information, into a medical information system during an ongoing medical procedure.

Medical practitioners, such as doctors, surgeons, and other medical professionals, rely on the clinical information stored in such systems to assess the condition of a patient, to provide immediate treatment to a patient in an emergency situation, to diagnose a patient, and/or to provide any other medical treatment or attention. In many instances, the clinical information includes voluminous patient medical histories containing detailed accounts of a plurality of medical events, treatments, modalities, diagnosis, prescriptions, etc. Parsing through the medical histories is time consuming and can be inefficient.

### SUMMARY

An example method to organize a patient medical history includes receiving a medical report and analyzing the medical report to extract information related to a clinical event associated with the medical report. Further, the example method includes assigning a classification to the medical report using the extracted information. Further, the example method includes determining a severity of the clinical event associated with the medical report using the extracted information and assigning a severity score to the medical report. Further, the example method includes updating a record corresponding to the medical report in a data store to reflect the assigned classification and severity score. Further, the example method includes enabling a healthcare practitioner to query the data store using the classification and severity score.

An example apparatus to organize a patient medical history includes a report analyzer to extract information from a medical report, wherein the information is related to a clinical event associated with the medical report. Further, the example apparatus includes a classification module to assign a classification to the medical report using the extracted information. Further, the example apparatus includes a severity measurement module to determine a severity of the clinical event associated with the medical report using the extracted information and to assign a severity score to the medical report. Further, the example apparatus includes a record updater to update a record corresponding to the medical report in a data store to reflect the assigned classification and severity score. Further, the example apparatus includes a user interface to enable a healthcare practitioner to query the data store using the classification and severity score.

### BRIEF DESCRIPTION OF THE DRAWINGS

FIG. 1 is a block diagram of an example medical information system.

FIG. 2 is a block diagram of an example apparatus that may be used to implement the example record organizer of FIG. 1.

FIG. 3 is a flow diagram representative of example machine readable instructions that may be executed to implement the example record organizer of FIG. 2.

FIG. 4 is an example screenshot of an example implementation of the example user interface of FIG. 1 to convey medical information using the example record organizer of FIG. 2.

FIG. 5 is a block diagram of an example processor system that may be used to execute the machine readable instructions of FIG. 3 to implement the example record organizer of FIG. 2.

The foregoing summary, as well as the following detailed description of certain implementations of the methods, apparatus, systems, and/or articles of manufacture described herein, will be better understood when read in conjunction with the appended drawings. It should be understood, however, that the methods, apparatus, systems, and/or articles of manufacture described herein are not limited to the arrangements and instrumentality shown in the attached drawings.

### DETAILED DESCRIPTION

Although the following discloses example methods, apparatus, systems, and articles of manufacture including, among other components, firmware and/or software executed on hardware, it should be noted that such methods, apparatus, and systems are merely illustrative and should not be considered as limiting. For example, it is contemplated that any or all of these firmware, hardware, and/or software components could be embodied exclusively in hardware, exclusively in software, exclusively in firmware, or in any combination of hardware, software, and/or firmware. Accordingly, while the following describes example methods, apparatus, systems, and/or articles of manufacture, the examples provided are not the only way(s) to implement such methods, apparatus, systems, and/or articles of manufacture.

The example methods and apparatus described herein can be used to organize medical records, such as patient medical histories. In particular, the example methods and apparatus described herein organize and/or arrange clinical information according to classification data and degrees of severity. Further, the example methods and apparatus described herein enable a healthcare professional to quickly and efficiently obtain patient information that is arranged according to classification and severity.

Typically, plain text medical reports include words and/or phrases indicative of observations, test results, treatment instructions, modalities, diagnosis, prescriptions, and/or any other relevant clinical information. Such words and/or phrases can be extracted and used to generally characterize the medical report. As described in greater detail below, using the extracted data to organize patient medical histories according to classification and severity increases efficiency and decreases the likelihood of mistakes, accidents, and/or oversights on the part of healthcare personnel. For example, when reviewing unorganized patient histories, important details or potential hazards may be overlooked, due in part to the sheer volume of the medical histories. A previous medical report in a patient history may include an indication that the patient had suffered severe trauma to a certain internal organ, the knowledge of which would significantly affect a physician's approach to treatment. Bringing such information to the physician's attention in the clearest manner possible is advantageous. Moreover, the extra time needed to carefully review unorganized or unsorted, large medical histories leads to inefficiency and, thus, less time to devote to diagnosis, other patients, or any other of the many tasks required of, for example, a physician, surgeon, or nurse.

However, current systems do not enable physicians to parse through a patient history using classification and severity as criteria. In contrast, the example methods and apparatus described herein enable an organization of clinical information according to classification and severity, as well as a user interface to convey the organized clinical information to a user (e.g., a physician, nurse, emergency room doctor, surgeon, etc.) in response to one or more commands.

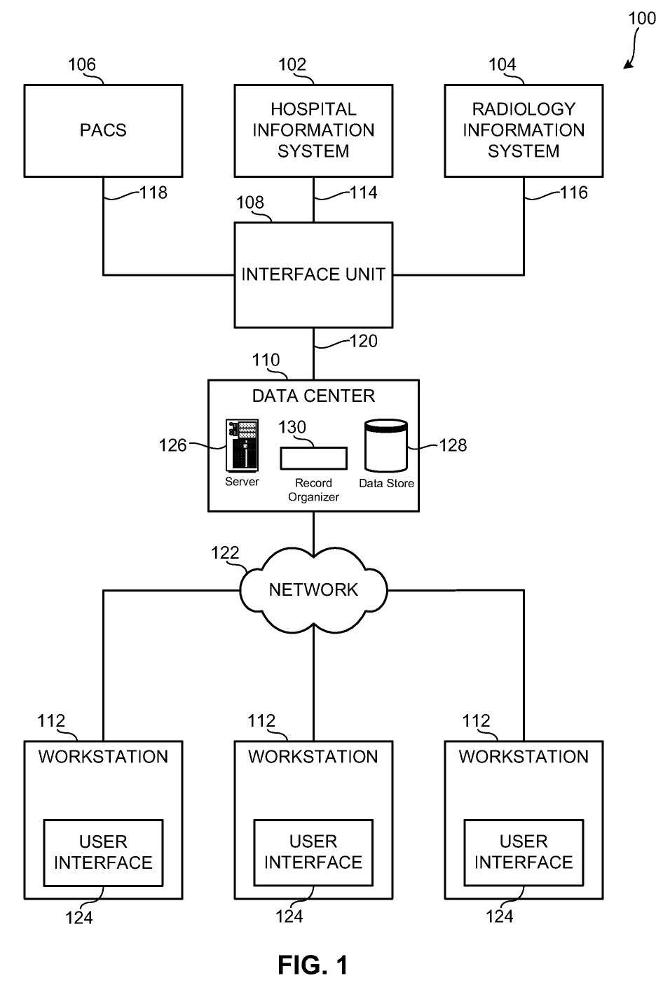

FIG. 1 is a block diagram of an example medical information system 100 capable of implementing the example methods and apparatus described herein to organize patient medical histories. The example medical information system 100 includes a hospital information system 102, a radiology information system 104, a picture archiving and communication system (PACS) 106, an interface unit 108, a data center 110, and a plurality of workstations 112. In the illustrated example, the hospital information system 102, the radiology information system 104, and the PACS 106 are housed in a healthcare facility and locally archived. However, in other implementations, the hospital information system 102, the radiology information system 104, and/or the PACS 106 may be housed one or more other suitable locations. Furthermore, one or more components of the medical information system 100 may be combined and/or implemented together. For example, the radiology information system 104 and/or the PACS 106 may be integrated with the hospital information system 102; the PACS 106 may be integrated with the radiology information system 104; and/or the three example information systems 102, 104, and/or 106 may be integrated together. In other example implementations, the medical information system 100 includes a subset of the illustrated information systems 102, 104, and/or 106. For example, the medical information system 100 may include only one or two of the hospital information system 102, the radiology information system 104, and/or the PACS 106. Preferably, information (e.g., test results, observations, diagnosis, etc.) is entered into the hospital information system 102, the radiology information system 104, and/or the PACS 106 by healthcare practitioners (e.g., radiologists, physicians, and/or technicians) before and/or after patient examination.

The hospital information system 102 stores medical information such as clinical reports, patient information, and/or administrative information received from, for example, personnel at a hospital, clinic, and/or a physician's office. The radiology information system 104 stores information such as, for example, radiology reports, messages, warnings, alerts, patient scheduling information, patient demographic data, patient tracking information, and/or physician and patient status monitors. Additionally, the radiology information system 104 enables exam order entry (e.g., ordering an x-ray of a patient) and image and film tracking (e.g., tracking identities of one or more people that have checked out a film). In some examples, information in the radiology information system 104 is formatted according to the HL-7 (Health Level Seven) clinical communication protocol.

The PACS 106 stores medical images (e.g., x-rays, scans, three-dimensional renderings, etc.) as, for example, digital images in a database or registry. In some examples, the medical images are stored in the PACS 106 using the Digital Imaging and Communications in Medicine (DICOM) format. Images are stored in the PACS 106 by healthcare practitioners (e.g., imaging technicians, physicians, radiologists) after a medical imaging of a patient and/or are automatically transmitted from medical imaging devices to the PACS 106 for storage. In some examples, the PACS 106 may also include a display device and/or viewing workstation to enable a healthcare practitioner to communicate (e.g., review images) with the PACS 106.

The interface unit 108 includes a hospital information system interface connection 114, a radiology information system interface connection 116, a PACS interface connection 118, and a data center interface connection 120. The interface unit 108 facilitates communication among the hospital information system 102, the radiology information system 104, the PACS 106, and/or the data center 110. The interface connections 114, 116, 118, and 120 may be implemented by, for example, a Wide Area Network (WAN) such as a private network or the Internet. Accordingly, the interface unit 108 includes one or more communication components such as, for example, an Ethernet device, an asynchronous transfer mode (ATM) device, an 802.11 device, a DSL modem, a cable modem, a cellular modem, etc. In turn, the data center 110 communicates with the plurality of workstations 112, via a network 122, implemented at a plurality of locations (e.g., a hospital, clinic, doctor's office, other medical office, or terminal, etc.). The network 122 is implemented by, for example, the Internet, an intranet, a private network, a wired or wireless Local Area Network, and/or a wired or wireless Wide Area Network. In some examples, the interface unit 108 also includes a broker (e.g., a Mitra Imaging's PACS Broker) to allow medical information and medical images to be transmitted together and stored together.

In operation, the interface unit 108 receives images, medical reports, administrative information, and/or other clinical information from the information systems 102, 104, 106 via the interface connections 114, 116, 118. If necessary (e.g., when different formats of the received information are incompatible), the interface unit 108 translates or reformats (e.g., into Structured Query Language (SQL or standard text) the medical information, such as medical reports, to be properly stored at the data center 110. Preferably, the reformatted medical information may be transmitted using a transmission protocol to enable different medical information to share common identification elements, such as a patient name or social security number. Next, the interface unit 108 transmits the medical information to the data center 110 via the data center interface connection 120. Finally, medical information is stored in the data center 110 in, for example, the DICOM format, which enables medical images and corresponding medical information to be transmitted and stored together.

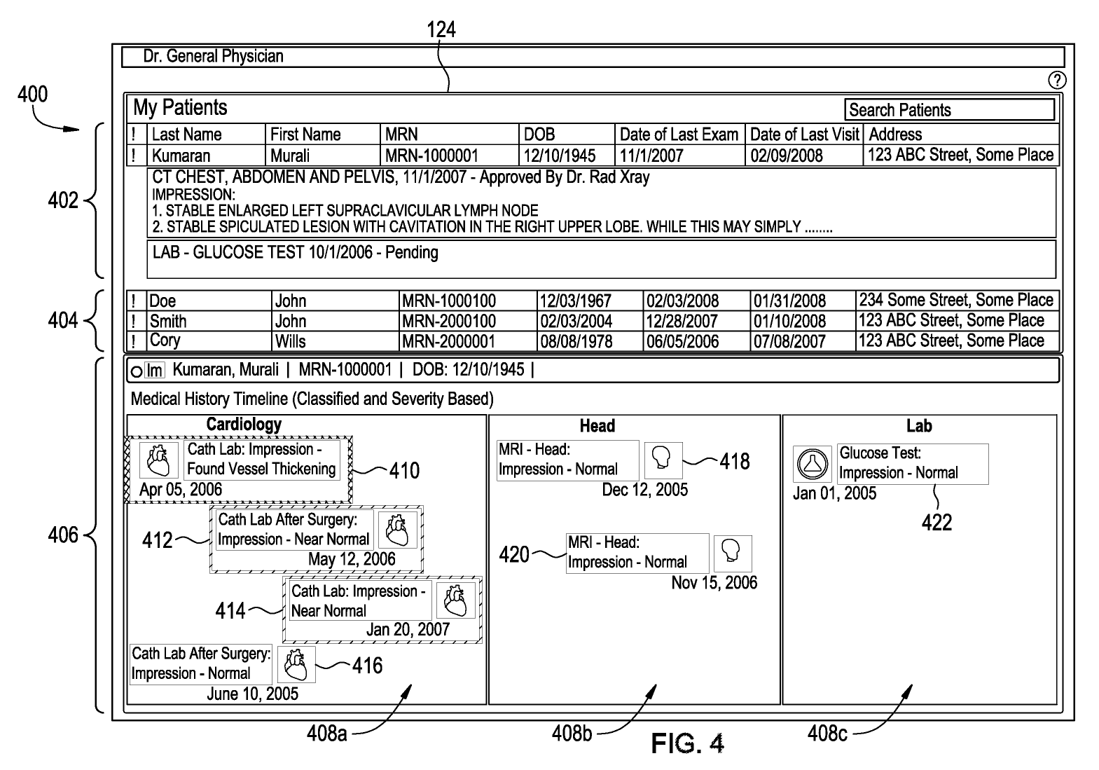

The medical information is later viewable and easily retrievable at one or more of the workstations 112 (e.g., by their common identification element, such as a patient name or record number). The workstations 112 may be any equipment (e.g., a personal computer) capable of executing software that permits electronic data (e.g., medical reports) and/or electronic medical images (e.g., x-rays, ultrasounds, MRI scans, etc.) to be acquired, stored, or transmitted for viewing and operation. The workstations 112 receive commands and/or other input from a user via, for example, a keyboard, mouse, track ball, microphone, etc. As shown in FIG. 1, the workstations 112 are connected to the network 122 and, thus, can communicate with each other, the data center 110, and/or any other device coupled to the network 122. As described in greater detail below in connection with FIG. 4, the workstations 112 are capable of implementing a user interface 124 to enable a healthcare practitioner to interact with the medical information system 100. For example, in response to a request from a physician, the user interface 124 presents a patient medical history. Additionally, the user interface 124 includes one or more options related to the example methods and apparatus described herein to organize such a medical history using classification and severity parameters.

The example data center 110 of FIG. 1 is an archive to store information such as, for example, images, data, medical reports, and/or, more generally, patient medical records. In addition, the data center 110 may also serve as a central conduit to information located at other sources such as, for example, local archives, hospital information systems/radiology information systems (e.g., the hospital information system 102 and/or the radiology information system 104), or medical imaging systems (e.g., the PACS 106). That is, the data center 110 may store links or indicators (e.g., identification numbers, patient names, or record numbers) to information. In the illustrated example, the data center 110 is managed by an application server provider (ASP) and is located in a centralized location that may be accessed by a plurality of systems and facilities (e.g., hospitals, clinics, doctor's offices, other medical offices, and/or terminals). In some examples, the data center 110 may be spatially distant from the hospital information system 102, the radiology information system 104, and/or the PACS 106 (e.g., at General Electric® headquarters).

The example data center 110 of FIG. 1 includes a server 126, a data store 128, and a record organizer 130. The server 126 receives, processes, and conveys information to and from the components of the medical information system 100. The data store 128 stores the medical information described herein and provides access thereto. The example record organizer 130 of FIG. 1 manages patient medical histories according to, inter alia, classification and severity of individual medical reports. Thus, a healthcare practitioner (e.g., a physician) is able to bring the most relevant, important data to a forefront of attention. Advantageously, the example record organizer 130 enables the practitioner to more quickly and efficiently obtain the medical information from a patient medical history. In addition, such an approach decreases the likelihood that critical information is missed or mistakenly overlooked. Further, the record organizer 130 enables the data center 110 to store the patient medical histories according to the associated classification and severity of each report. For example, reports associated with less severe medical events can be moved to long term electronic storage in the data store 128 and reports associated with more severe medical events can be moved to short term storage (e.g., a cache) in the data store 128. Such an approach provides faster access to the reports associated with more severe medical events.

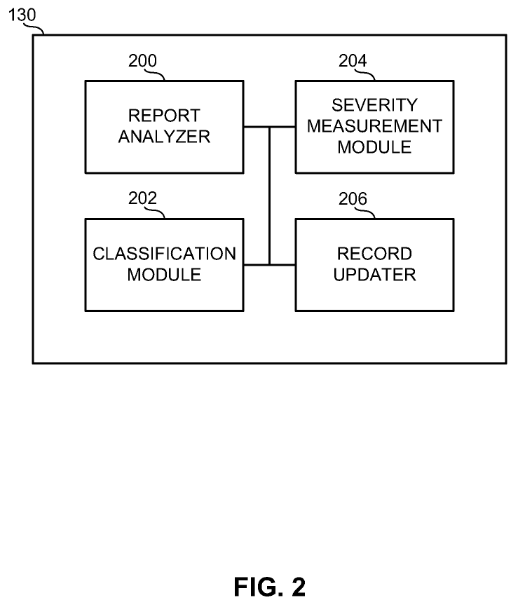

FIG. 2 is a block diagram of an example apparatus that may be used to implement the example record organizer 130 of FIG. 1. In the illustrated example of FIG. 2, the example record organizer 130 includes a report analyzer 200, a classification module 202, a severity measurement module 204, and a record updater 206. While an example manner of implementing the record organizer 130 of FIG. 1 has been illustrated in FIG. 2, one or more of the elements, processes and/or devices illustrated in FIG. 2 may be combined, divided, re-arranged, omitted, eliminated and/or implemented in any other way. Further, the example report analyzer 200, the example classification module 202, the example severity measurement module 204, the example record updater 206, and/or, more generally, the example record organizer 130 of FIG. 2 may be implemented by hardware, software, firmware and/or any combination of hardware, software and/or firmware. Thus, for example, any of the example report analyzer 200, the example classification module 202, the example severity measurement module 204, the example record updater 206, and/or, more generally, the example record organizer 130 of FIG. 2 can be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended claims are read to cover a purely software and/or firmware implementation, at least one of the example report analyzer 200, the example classification module 202, the example severity measurement module 204, the example record updater 206, and/or, more generally, the example record organizer 130 of FIG. 2 are hereby expressly defined to include a tangible medium such as a memory, DVD, CD, etc., storing the software and/or firmware. Further still, the example record organizer 130 of FIG. 2 may include one or more elements, processes and/or devices in addition to, or instead of, those illustrated in FIG. 2, and/or may include more than one of any or all of the illustrated elements, processes and devices.

To extract data and/or identifiers from a medical report (e.g., a plain text record), the record organizer 130 conveys received medical reports to the report analyzer 200. In addition, data and/or identifiers may be extracted from electronic medical records (EMRs), optical character recognition (OCR), a medication order system, a database, a computerized physician order entry (CPOE), and/or any other suitable source. The report analyzer 200 implements one or more algorithms capable of scanning the medical record and identifying one or more key words, phrases, abbreviations, instructions, etc. that are representative of a modality, diagnosis, prescriptions, or any other relevant treatment information. An example system and method for extracting the data and/or identifiers is described in U.S. patent application Ser. No. 11/107,695, entitled “System and Method for Parsing Medical Data,” published on Oct. 19, 2006, as United States Patent Publication No. 2006/0235881, which is incorporated herein in its entirety. In addition, in the illustrated example of FIG. 2, the report analyzer 200 creates a software object to represent the received medical report. The software object includes a plurality of properties that can be altered by, for example, the classification module 202 and/or the severity measurement module 204.

The extracted representative data can then be used to recognize different details of the medical event associated with the medical report. In the illustrated example of FIG. 2, the classification module 202 receives the extracted data and determines a classification of the medical report. For example, when the medical report comprises blood work, the classification module 202 parses through the extracted representative information to obtain, for example, an identifier associated with the type of testing, the results of the testing, a related modality, a body part associated with the testing, an area of medicine (e.g., cardiology, neurology, etc.), or any other suitable classification. The classification module 202 then assigns a label to the medical report that can later be used by a user interface (e.g., the example user interface 124 described in connection with FIG. 4) to categorize the medical report (e.g., among other medical reports) according to the detected classification. In the illustrated example of FIG. 2, assigning the label includes changing a value of a classification property of the software object (created by the report analyzer 200) associated with the received medical report.

The severity measurement module 204 also receives the extracted data (e.g., from the report analyzer 200) and determines a severity of the associated medical report. In particular, the severity measurement module 204 parses through the extracted data and/or identifiers to obtain, for example, an identifier associated with the severity of the results. To continue the above example, the medical report associated with the blood work may indicate that the results were problematic. In such an instance, the degree of the problematic results can be, for example, normal, near normal, tolerable, problematic, in need of further testing, inconclusive, mild, concerning, severe, life-threatening, requiring immediate attention, or any other suitable degree of severity. The severity measurement performed by the severity measurement module 204 can be based on a plurality of factors contained in the medical report such as, for example, a body part (e.g., some body parts are more critical and involve higher risks than others), a performed procedure (e.g., by risk of complications), modality, and/or findings. The severity measurement module 204 then assigns a score to the medical report that can later be used by a user interface (e.g., the example user interface 124 described in connection with FIG. 4) to categorize the medical report (e.g. among other medical reports) according to the detected severity. In the illustrated example of FIG. 2, assigning the score comprises changing a value of a severity property of the software object (created by the report analyzer 200) associated with the received medical report.

While the example report analyzer 200 of FIG. 2 is illustrated as separate from the classification module 202 and the severity measurement module 204, the report analyzer 200 may alternatively be included in the classification module 202 and/or the severity measurement module 204. In other words, the classification module 202 and/or the severity measurement module 204 may implement the functionality of the report analyzer 200 in addition to the other functions described herein.

Medical reports that have been assigned a classification by the classification module 202 and that have been assigned a score by the severity measurement module 204 are conveyed to the record updater 206. The record updater 206 uses the classification and severity information to assign values to the properties associated with each medical report. Specifically, in the illustrated example of FIG. 2, the record updater 206 assigns values to the properties of the software object (created by the report analyzer 200) associated with the medical report according to the determinations made by the classification module 202 and the severity measurement module 204. Additionally, the record updater 206 assigns a value to a storage property (e.g., a storage priority) that is used by the data store 128 (FIG. 1) to store the medical report. For example, if the severity of the medical event described in the medical report is high or life-threatening, the record updater 206 of FIG. 2 assigns the medical report a ‘short-term’ value for its storage property. The data store 128 uses this property to store the medical report in a faster memory such as a cache to enable quick retrieval. If the severity of the medical event described in the medical report is low or normal, the record updater 206 of FIG. 2 assigns the medical report a ‘long-term’ value for its storage property. The data store 128 uses this property to store the medical report in a slower memory.

As described above, the record organizer 130 then conveys the medical report (e.g., the software object associated with the medical report) to the data store 128 for storage, where it can later be retrieved using one of the workstations 112 (FIG. 1). Thus, a healthcare practitioner is able to view a patient medical history using classification as a sorting and/or searching criteria to obtain the most relevant information desired by a physician.

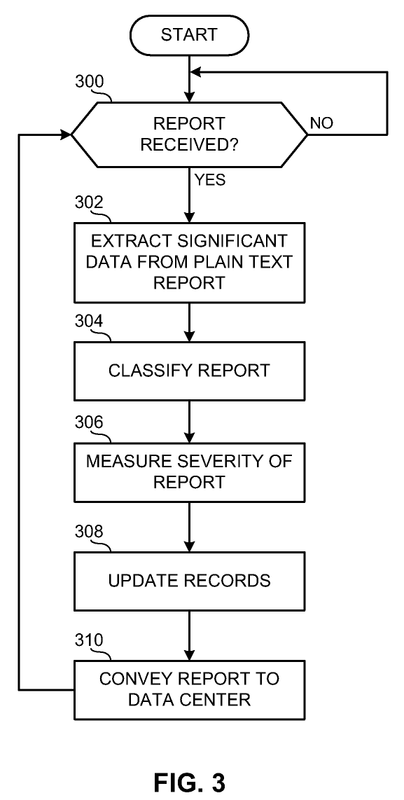

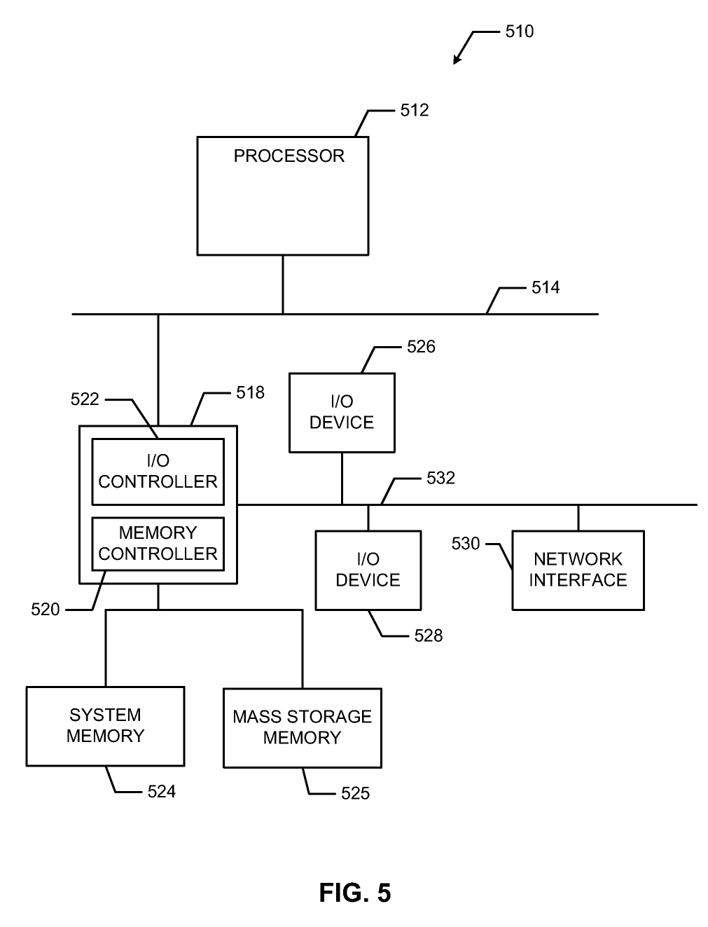

The flow diagram depicted in FIG. 3 is representative of machine readable instructions that can be executed to implement the example methods and apparatus described herein. In particular, FIG. 3 depicts a flow diagram representative of machine readable instructions that may be executed to implement the example record organizer 130 of FIGS. 1 and/or 2 to organize patient medical histories according to classification and severity. The example processes of FIG. 3 may be performed using a processor, a controller and/or any other suitable processing device. For example, the example processes of FIG. 3 may be implemented in coded instructions stored on a tangible medium such as a flash memory, a read-only memory (ROM) and/or random-access memory (RAM) associated with a processor (e.g., the example processor 512 discussed below in connection with FIG. 5). Alternatively, some or all of the example processes of FIG. 3 may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example processes of FIG. 3 may be implemented manually or as any combination(s) of any of the foregoing techniques, for example, any combination of firmware, software, discrete logic and/or hardware. Further, although the example processes of FIG. 3 are described with reference to the flow diagram of FIG. 3, other methods of implementing the processes of FIG. 3 may be employed. For example, the order of execution of the blocks may be changed, and/or some of the blocks described may be changed, eliminated, sub-divided, or combined. Additionally, any or all of the example processes of FIG. 3 may be performed sequentially and/or in parallel by, for example, separate processing threads, processors, devices, discrete logic, circuits, etc.

Turning to FIG. 3, initially the record organizer 130 waits to receive a medical report from, for example, a healthcare practitioner after an appointment or from medical equipment configured to automatically convey test results or other medical reports to the record organizer 130 after a test is performed (block 300). A received medical report (e.g., a plain text report) is conveyed to the report analyzer 200 (FIG. 2), which extracts information (e.g., via an OCR process) representative of the elements of the medical report (block 302). As described above, the extracted information is used to characterize or organize the medical reports of a patient history. In addition, in the illustrated example of FIG. 3, the report analyzer 200 creates a software object to represent the medical report.

The extracted information is conveyed to the classification module 202 (FIG. 2) to classify the medical report (block 304). For example, the classification module 202 may label the medical report as related to a certain body part or modality, or any other suitable classification. The extracted information is also conveyed to the severity measurement module 204 (FIG. 2) to assess the severity of the medical event associated with the medical report (block 306). For example, the severity measurement module 204 may determine that the medical event is normal, near normal, tolerable, problematic, in need of further testing, inconclusive, mild, concerning, severe, life-threatening, requiring immediate attention, or any other suitable degree of severity. The severity measurement performed by the severity measurement module 204 can be based on a plurality of factors contained in the medical report such as, for example, a body part, a performed procedure, modality, and/or findings.

In the illustrated example, the record updater 206 (FIG. 2) then updates the record (e.g., the software object) associated with the medical report (block 308). In particular, the record updater 206 alters a classification property of the software object representing the medical report according to the determination made regarding the classification of the medical report by the classification module 202. Further, the record updater 206 alters a severity property of the software object representing the medical report according to the determination made regarding the severity of the events or conditions described in the medical report by the severity measurement module 204. Further, the record updater 206 alters a storage property of the software object representing the medical report according to the determinations made by the classification module 202 and the severity measurement module 204. For example, severe cases may cause the record updater 206 to assign the storage property a value indicative of a preference to be stored in a short-term component such as, for example, a cache. Less severe cases may cause the record updater 206 to assign the storage property a valued indicative of a preference to be stored in a long-term component.

The medical report (e.g., the software object associated with the medical report) is then transmitted to the server 126 and/or the data store 128 (FIG. 1) for storage (block 310). As described above, the workstations 112 (FIG. 1) have access to the data store 128 and, thus, the medical reports that have been organized according to classification and severity.

FIG. 4 is an example screen shot 400 of an example implementation of the example user interface 124 of FIG. 1 to convey medical information using the example record organizer 130 of FIG. 2. As shown in FIG. 1, the example user interface 124 of FIG. 4 is implemented on one or more of the workstations 112. Additionally or alternatively, the user interface 124 may be implemented on another device including, for example, a personal digital assistant (PDA), a personal computer located at a healthcare facility, a residence, a business, etc., a cellular telephone, or any other suitable information presentation device. The user interface 402 and the various features and components thereof are meant for illustrative purposes and are not to be construed as limiting. Other example user interfaces may be employed to convey medical data using the methods, apparatus, systems, and/or articles of manufacture described herein.

The example user interface 124 of FIG. 4 includes a selected patient information section 402, an example patient list 404, and an example medical history section 406. The example selected patient information section 402 includes data related to a selected patient such as first and last names, registration and/or patient number, date of birth, date of last examination, data of last visit, a home address, recent test information, or any other suitable information (e.g., additional or alternative bibliographic information). This information is displayed in response to a physician (or any other type of authorized user) selecting a patient (e.g., by clicking on a patient name with a cursor being manipulated by a mouse). For example, the physician may select a patient from the example patient list 404 of FIG. 4. The example patient list 404 includes a subset of the information presented in the selected patient information section 402 to enable an identification of one or more patients of particular interest to the physician at a given time.

When a patient is selected (e.g., from the patient list 404), the medical history section 406 is populated with information related to one or more medical events. As described above, the record organizer 130 of FIG. 2 enables such medical information to be organized and viewed according to classification and severity, thereby bringing crucial or critical information to the immediate attention of the physician. In contrast to previous systems, the example user interface 124 of FIG. 4 enables the physician to more quickly and efficiently obtain important medical information from a medical history. In addition, the manner in which the example medical history section 406 is configured (e.g., to display information as organized by the record organizer 130 (e.g., by classification and severity)) decreases the likelihood that critical information is missed or mistakenly overlooked.

Specifically, the example medical history section 406 includes a plurality of classification segments 408a-c that are populated with items related to one or more medical events associated with the selected patient. In the illustrated example, the medical history section 406 includes a cardiology classification segment 408a, a head classification segment 408b, and a lab classification segment 408c. As described in greater detail above, the report analyzer 200 (FIG. 2) analyzes medical reports to extract information (e.g., via optical character recognition (OCR)) that can be interpreted by the other components of the record organizer 130. The classification module 202 (FIG. 2) receives the extracted data and determines a classification (e.g., based on a type of testing, the results of the testing, a related modality, a body part associated with the testing, an area of medicine (e.g., cardiology, neurology, etc.), or any other suitable classification) of the medical report. The classification module 202 then assigns a label (e.g., by changing a value of a classification property of a software object created by the report analyzer 200) that is used by the user interface 124 to display the medical reports according to the assigned classifications.

For instance, in the illustrated example of FIG. 4, the selected patient has experienced events that resulted in medical reports that fall into the three classifications defined by the three classification segments 408a-c of FIG. 4. Specifically, the medical history of the selected patient includes first, second, third, and fourth medical reports 410, 412, 414, and 416 classified as a cardiology reports; fifth and sixth medical reports 418 and 420 classified as head-related medical reports; and a seventh medical report 422 classified as a lab-related medical report. Accordingly, the user interface 124 divides the medical reports 410-422 into their respective classifications by segmenting the medical history section 406 as shown in FIG. 4. Thus, if the patient is introduced to the physician (e.g., in an emergency room) as complaining of chest pains, using the methods, apparatus, systems, and articles of manufacture described herein as conveyed by the example user interface 124 of FIG. 4, the physician can immediately access and evaluate the cardiology medical reports associated with the patient. The cardiology reports are shown together and isolated from medical reports of other classifications to increase speed of review (e.g., by eliminated the need to parse through irrelevant data such as a medical report related to a broken wrist) and to decrease the likelihood that some previous cardiac event is overlooked by the physician or other healthcare staff.

Further, the data extracted and analyzed by the report analyzer 200 is also received by the severity measurement module 204 (FIG. 2). As described above, the severity measurement module 204 determines a severity (e.g., normal, near normal, tolerable, problematic, in need of further testing, inconclusive, mild, concerning, severe, life-threatening, requiring immediate attention, or any other suitable degree of severity) of the associated medical report and assigns a score (e.g., by changing a value of a severity property of a software object created by the report analyzer 200) to the medical report that is used by the example user interface 124 to display the medical reports according to the detected severity. The severity measurement performed by the severity measurement module 204 can be based on a plurality of factors contained in the medical report such as, for example, a body part, a performed procedure, modality, and/or findings.

For instance, in the illustrated example of FIG. 4, there are four cardiology medical reports associated with the selected patient. The reports include the first report 410 having a severity of ‘Found vessel thickening,’ the second medical report 412 having a severity of ‘Near Normal,’ the third medical report 414 having a severity of ‘Near Normal,’ and the fourth medical report 416 having a severity of ‘Normal.’ As shown in FIG. 4, the first medical report 410 is disposed in the cardiology classification segment 408a at a position most likely to draw the attention of the physician (e.g., the top of the cardiology segment 408a) because the severity thereof is ‘Found vessel thickening,’ which is a condition or severity that clearly warrants the attention of the physician. The second and third medical reports 412, 414 are disposed beneath the first medical report 410 due to their severity of ‘Near Normal.’ Finally, the third medical report 416 is disposed beneath the first and second medical reports 412, 414 due to its severity of ‘Normal.’ The head and lab classification segments 408b-c are configured in a similar manner as the cardiology segment 408a. However, the medical reports of the head segment 408b-c are of the same severity (Normal) and, thus, are only arranged by time and date of occurrence (e.g., across the horizontal). Such an approach is an example default arrangement for situations in which medical reports are of the same severity. The lab classification segment 408c includes only one medical report and, thus, requires no organization according to severity.

The severity of the medical reports can also be conveyed in additional or alternative manners. In the illustrated example, the user interface 124 uses the severity score of the medical reports to further delineate (e.g., in addition to the vertical arrangement) the medical reports by outlining or framing some or all of the medical reports according to their severity. For instance, a medical report associated with a highly severe condition or event may be outlined or framed with a different color (e.g., red) than a medical report associated with a less sever condition or event. Additionally or alternatively, the border pattern of the outlines or frames may vary according to severity. In the illustrated example, the first medical report 410, which is associated with a highly severe condition, is outlined having a first border pattern, while the second and third medical reports, which are associated with a less severe condition, are outlined having a second, different border pattern. Further, the fourth, fifth, sixth, and seventh medical reports 416-422 are not outlined or bordered due to their low severity (e.g., ‘Normal’). Thus, to refer back to the above example, if the patient is introduced to the physician (e.g., in an emergency room) as complaining of chest pains, using the methods, apparatus, systems, and articles of manufacture described herein as conveyed by the example user interface 124 of FIG. 4, the physician can immediately access and evaluate the most severe medical events experienced by the patient. In particular, as a result of the classification module 202 described herein, the physician can immediately access and evaluate the most severe cardiac medical events associated with the patient.

FIG. 5 is a block diagram of an example processor system 510 that may be used to implement the apparatus and methods described herein. As shown in FIG. 5, the processor system 510 includes a processor 512 that is coupled to an interconnection bus 514. The processor 512 may be any suitable processor, processing unit or microprocessor. Although not shown in FIG. 5, the system 510 may be a multi-processor system and, thus, may include one or more additional processors that are identical or similar to the processor 512 and that are communicatively coupled to the interconnection bus 514.

The processor 512 of FIG. 5 is coupled to a chipset 518, which includes a memory controller 520 and an input/output (I/O) controller 522. As is well known, a chipset typically provides I/O and memory management functions as well as a plurality of general purpose and/or special purpose registers, timers, etc. that are accessible or used by one or more processors coupled to the chipset 518. The memory controller 520 performs functions that enable the processor 512 (or processors if there are multiple processors) to access a system memory 524 and a mass storage memory 525.

The system memory 524 may include any desired type of volatile and/or non-volatile memory such as, for example, static random access memory (SRAM), dynamic random access memory (DRAM), flash memory, read-only memory (ROM), etc. The mass storage memory 525 may include any desired type of mass storage device including hard disk drives, optical drives, tape storage devices, etc.

The I/O controller 522 performs functions that enable the processor 512 to communicate with peripheral input/output (I/O) devices 526 and 528 and a network interface 530 via an I/O bus 532. The I/O devices 526 and 528 may be any desired type of I/O device such as, for example, a keyboard, a video display or monitor, a mouse, etc. The network interface 530 may be, for example, an Ethernet device, an asynchronous transfer mode (ATM) device, an 802.11 device, a DSL modem, a cable modem, a cellular modem, etc. that enables the processor system 510 to communicate with another processor system.

While the memory controller 520 and the I/O controller 522 are depicted in FIG. 5 as separate blocks within the chipset 518, the functions performed by these blocks may be integrated within a single semiconductor circuit or may be implemented using two or more separate integrated circuits.

Certain embodiments contemplate methods, systems and computer program products on any machine-readable media to implement functionality described above. Certain embodiments may be implemented using an existing computer processor, or by a special purpose computer processor incorporated for this or another purpose or by a hardwired and/or firmware system, for example.

Certain embodiments include computer-readable media for carrying or having computer-executable instructions or data structures stored thereon. Such computer-readable media may be any available media that may be accessed by a general purpose or special purpose computer or other machine with a processor. By way of example, such computer-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

Although certain methods, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

What is claimed is:

1. A computer-implemented method to organize a patient medical history, comprising:
receiving a medical report and analyzing the medical report to extract information related to a clinical event associated with the medical report;
assigning a classification to the medical report using the extracted information;
determining a severity of the clinical event associated with the medical report using the extracted information and assigning a severity score to the medical report;
updating a record corresponding to the medical report in a data store to reflect the assigned classification and severity score; and
enabling a healthcare practitioner to query the data store using the classification and severity score.

2. A method as defined in claim 1, further comprising implementing a user interface capable of conveying information associated with the patient medical history, wherein the user interface includes an option to arrange information according to the classification and severity.

3. A method as defined in claim 1, further comprising generating an object to represent the medical report.

4. A method as defined in claim 3, wherein assigning the classification to the medical report and assigning the severity score to the medical report comprise assigning values to properties of the object.

5. A method as defined in claim 1, further comprising determining a storage priority for the medical report based on at least one of the classification or the severity score.

6. A method as defined in claim 5, wherein the storage priority determines whether the medical report is stored in a cache or a long-term memory.

7. A method as defined in claim 1, wherein the severity is based on at least one of a body part, a performed procedure, a modality, or one or more findings.

8. A method as defined in claim 1, wherein enabling the healthcare practitioner to query the data store using the assigned classification and severity score comprises providing a search function capable of using one or more values associated with the classification and severity score as search criteria.

9. An apparatus to organize a patient medical history, comprising:
a report analyzer to extract information from a medical report, wherein the information is related to a clinical event associated with the medical report;
a classification module to assign a classification to the medical report using the extracted information;
a severity measurement module to determine a severity of the clinical event associated with the medical report using the extracted information and to assign a severity score to the medical report;
a record updater to update a record corresponding to the medical report in a data store to reflect the assigned classification and severity score; and
a user interface to enable a healthcare practitioner to query the data store using the classification and severity score.

10. An apparatus as defined in claim 9, wherein the report analyzer generates an object to represent the medical report.

11. An apparatus as defined in claim 10, wherein the classification and the severity score comprise values to be assigned to properties of the object.

12. An apparatus as defined in claim 9, wherein the record updater determines a storage priority for the medical report based on at least one of the classification or the severity score.

13. An apparatus as defined in claim 12, wherein the storage priority determines whether the medical report is stored in a cache or a long-term memory.

14. An apparatus as defined in claim 9, wherein the severity is based on at least one of a body part, a performed procedure, a modality, or one or more findings.

15. A medical information system, comprising:
one or more data entry systems to receive medical reports including information related to clinical events associated with the medical reports;
a data center in communication with the data entry systems to receive and store the medical reports in a data store;
a record organizer comprising:
a classification module to assign classifications to the medical reports;
a severity measurement module to assign severity scores to the medical reports based on the information related to the clinical events associated with the medical reports;
a record updater to update records corresponding to the medical reports in the data store to reflect the assigned classifications and severity scores; and
one or more workstations in communication with the data store, wherein the workstations implement a user interface to enable a healthcare practitioner to query the data store using the classifications and severity scores.

16. A medical information system as defined in claim 15, further comprising a report analyzer to extract data from the medical reports for use in assigning the classifications and severity scores.

17. A medical information system as defined in claim 15, wherein the workstations are in communication with the data store via a network.

18. A medical information system as defined in claim 15, further comprising software objects stored in the data store to represent the medical reports.

19. A medical information system as defined in claim 15, further comprising storage priorities stored in association with the medical reports, wherein the storage priorities are based on at least one of the classification or the severity.

20. A medical information system as defined in claim 19, wherein the storage priorities determine whether the medical reports are stored in a cache or a long-term memory.
